(19) United States
(12) Patent Application Publication
(10) Pub. No.: US 2022/0343621 A1
(43) Pub. Date: Oct. 27, 2022

(54) TRACKING SYSTEM FOR IDENTIFICATION OF SUBJECTS

(71) Applicant: The Johns Hopkins University, Baltimore, MD (US)

(72) Inventors: Fabio MARCUCCIO, Turin (IT); Alena V. SAVONENKO, Pikesville, MD (US); Ralph ETIENNE-CUMMINGS, Washington, DC (US); Duncan Elliot PARKE, Baltimore, MD (US)

(73) Assignee: The Johns Hopkins University, Baltimore, MD (US)

(21) Appl. No.: 17/641,060

(22) PCT Filed: Sep. 2, 2020
(86) PCT No.: PCT/US2020/070485

§ 371 Date: Mar. 7, 2022

Related U.S. Application Data
(60) Provisional application No. 62/897,783, filed on Sep. 9, 2019.

(51) Int. Cl. G06V 10/26; G06T 7/246; G06V 10/75; G06V 10/14

(52) U.S. Cl. CPC G06V 10/26; G06T 7/246; G06V 10/7553; G06V 10/14; G06T 2207/10048; G06V 2201/07

(57) ABSTRACT

A device may identify, in a first frame of a video feed captured by a camera and using a first computer vision technique, a first subject based on a plurality of reference points of the first subject. The device may determine whether the first subject is merged with a second subject in a second frame of the video feed. The device may selectively identify the first subject in the second frame using the first computer vision technique, or using a second computer vision technique, based on whether the first subject is merged with the second subject in the second frame, wherein the second computer vision technique is based on a shape context of the first subject. The device may determine log information based on identifying the first subject in the first frame and the second frame. The device may store or provide the log information.

### CROSS-REFERENCE TO RELATED APPLICATION

This Patent application claims priority to U.S. Provisional Patent Application No. 62/897,783, filed on Sep. 9, 2019, and entitled “TRACKING SYSTEM FOR IDENTIFICATION OF SUBJECTS.” The disclosure of the prior Application is considered part of and is incorporated by reference into this Patent Application.

### BACKGROUND

Some forms of experimentation may be performed using live subjects such as rodents. For example, behavior of rodents in an enclosure may be monitored to determine the effects of particular environmental factors, chemicals, and/or the like. This may be useful, for example, for neurobehavioral analysis based on monitoring mouse social behavior.

### SUMMARY

According to some implementations, a method may include identifying, in a first frame of a video feed captured by a camera and using a first computer vision technique, a first subject based on a plurality of reference points of the first subject; determining whether the first subject is merged with a second subject in a second frame of the video feed; selectively identifying the first subject in the second frame using the first computer vision technique, or using a second computer vision technique, based on whether the first subject is merged with the second subject in the second frame, wherein the second computer vision technique is based on a shape context of the first subject; determining log information associated with the first subject or the second subject based on identifying the first subject in the first frame and the second frame; and storing or providing the log information.

According to some implementations, a system may include a mouse vivarium; a camera to capture a video feed of a floor surface of the mouse vivarium in a near-infrared range or an infrared range; a near-infrared or infrared light source to illuminate the mouse vivarium; one or more processors communicatively coupled to the camera and configured to identify one or more subjects in the video feed; and an interaction device configured to perform an interaction with the one or more subjects in the mouse vivarium based on a signal from the one or more processors.

According to some implementations, a device may include one or more memories and one or more processors, communicatively coupled to the one or more memories, configured to: receive configuration information for an operation to be performed based on subjects associated with a plurality of enclosures, wherein the plurality of enclosures are associated with respective cameras and respective processors, and wherein the configuration information indicates one or more trigger conditions associated with the operation; configure the respective processors of the plurality of enclosures based on the configuration information; receive, from the respective processors, at least one of log information or video information associated with the operation; determine that a trigger condition, of the one or more trigger conditions, is satisfied; and store or provide at least part of the log information or at least part of the video information based on the trigger condition being satisfied.

### BRIEF DESCRIPTION OF THE DRAWINGS

FIG. 1 is a diagram of an example of a subject tracking system, described herein.

FIG. 2 is a diagram of an example environment in which systems and/or methods described herein may be implemented.

FIG. 3 is a diagram of example components of one or more devices of FIG. 2.

FIGS. 4A and 4B are diagrams of an example of operations performed by a system described herein.

FIG. 5 is a diagram of an example process for subject tracking, as described herein.

FIG. 6 is a diagram of an example of reference points of a set of subjects, as described herein.

FIG. 7 is a diagram of an example of subject tracking based on centers of a shape associated with a subject and reference points associated with the subject, as described herein.

FIG. 8 is a flowchart of an example process for tracking subjects using a subject tracking system.

FIG. 9 is a flowchart of an example process for tracking subjects in multiple enclosures.

### DETAILED DESCRIPTION

The following detailed description of example implementations refers to the accompanying drawings. The same reference numbers in different drawings may identify the same or similar elements.

Behavioral testing, such as behavioral testing of disease models, may involve the observation of subjects (e.g., laboratory animals, such as mice, rats, and/or the like) for social interactions or other behaviors. Behavioral testing may be a time-consuming and laborious process that is vulnerable to the effects of human handling and lack of standardization, leading to low reproducibility. For example, conditions of testing between different enclosures (e.g., mouse vivariums and/or the like), different facilities, or different operations may be different, leading to inconsistency in analysis of subject behaviors. Furthermore, human handling of subjects may introduce stress or behavioral inconsistency for subjects, and may significantly lengthen the time required for studies. Still further, animal-based behavioral testing for some diseases, such as Alzheimer's disease, may involve extremely large sample sizes, due to the need to accommodate testing at different stages of pathology, different drug doses, different strain backgrounds, and so on. Even further, some testing paradigms may involve the relocation of subjects to testing enclosures, which may disrupt colonies of the subjects. Thus, maintaining rigorous standards for subject handling, pathology, testing consistency, and so on may constrain the throughput of some laboratories.

Implementations described herein provide a high-throughput cognitive testing system for testing of animal subjects (e.g., mice, rats, and/or the like). For example, multiple subjects may be observed contemporaneously in standard mouse housing, such as in home cages of the subjects, which reduces variability due to handling of the subjects or inconsistent testing environments, and which allows testing of cognitive and behavioral phenotypes in undisturbed colonies of subjects that are housed with their established social groups. Furthermore, implementations described herein may perform characterization and/or analysis of such cognitive and behavioral phenotypes using computer vision algorithms that enable tracking and identification of each subject in an enclosure (e.g., for multiple subjects) in real time or substantially real time. Furthermore, implementations described herein may use different computer vision techniques based on whether or not two or more subjects have merged (e.g., have overlapped or adjacent visual borders), thereby enabling higher-efficiency processing when the two or more subjects have not merged, and more accurate processing (e.g., capable of differentiating merged subjects), such as a shape context based procedure, when the two or more subjects have merged. Still further, implementations described herein provide modularity for interaction devices (e.g., feeders, lickometers, shockers, and/or the like), software (e.g., for automatic classification of behavior repertoires, social hierarchy, and/or the like), telemetry-based data collection (e.g., heart rate, temperature, and/or the like), or other functions. Thus, implementations described herein increase the accuracy and scalability of subject observation and testing, conserve processor resources that would otherwise be used to indiscriminately perform a shape context based procedure for subject identification, and reduce inaccuracy associated with indiscriminately performing a higher-efficiency processing procedure.

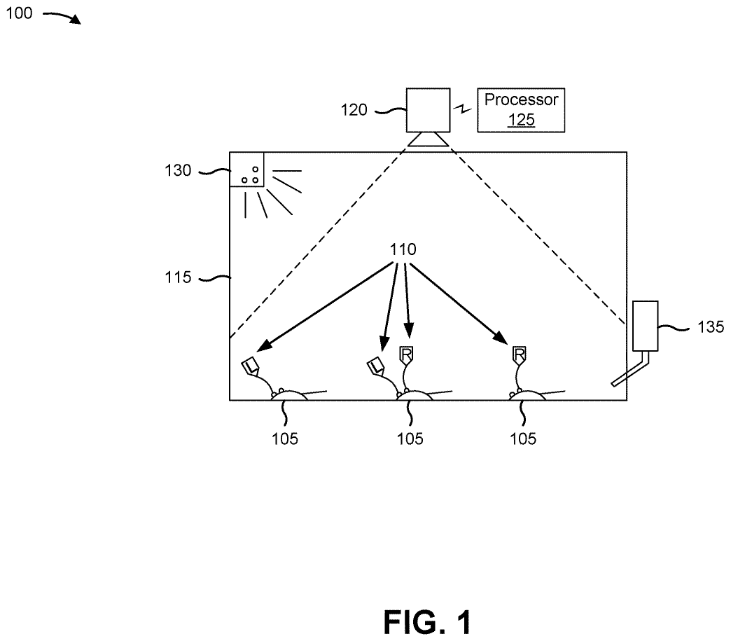

FIG. 1 is a diagram of an example of a subject tracking system 100, described herein. Subject tracking system 100 may track subjects 105, which may be laboratory animals (e.g., a standardized lab mouse, such as a C57BL lab mouse) or another type of subject. In some implementations, subjects 105 may be associated with tags 110. Tag 110 may include an object that is visible to a camera. In some implementations, tag 110 may include an ear tag or another type of tag affixed to subject 105. In some aspects, tag 110 may include a standard ear tag (e.g., with a size of approximately 3-5 mm). In some aspects, tag 110 may differentiate subjects 105. Here, a first subject 105 is associated with only a left (L) tag, a second subject 105 is associated with only a right (R) tag, and a third subject 105 is associated with L and R tags. A fourth subject (not shown) may be differentiated from the three subjects 105 by affixing neither the L tag nor the R tag to the fourth subject. The usage of tags 110 may conserve cost and computing resources associated with other types of subject identifiers, such as radio frequency identifier (RFID) tags and/or the like. In some aspects, tag 110 may include an RFID tag, a near field communication chip, and/or the like.

One or more subjects 105 may be enclosed in an enclosure 115. Enclosure 115 may comprise any enclosure, cage, chamber, and/or the like. In some aspects, enclosure 115 may comprise a mouse vivarium, such as a standardized mouse vivarium. In some implementations, a plurality of subjects 105 may be enclosed in enclosure 115. For example, subject tracking system 100 may be capable of tracking two subjects, four subjects, or a different number of subjects, and up to the trackable number of subjects may be enclosed in enclosure 115.

Subject tracking system 100 may include a camera 120. Camera 120 includes a device capable of capturing a video or image. For example, camera 120 may capture video information (e.g., a video feed, a video, multiple videos, multiple video feeds, and/or the like), image information (e.g., a sequence of images), and/or the like. In some implementations, camera 120 may be associated with an infrared (IR) or near-IR (NIR) range. For example, camera 120 may be capable of capturing wavelengths in the IR or NIR range. This may enable the observation of subjects 105 without interrupting the circadian rhythms of the subjects 105 by using visible light, thereby improving accuracy and reproducibility of operations that are observed using subject tracking system 100. In some implementations, camera 120 may include a wide angle camera (e.g., a camera associated with a threshold field of view, such as 150 degrees, 160 degrees, 175 degrees, and/or the like). In some aspects, a video captured by camera 120 may depict an entirety of a floor surface of enclosure 115 (e.g., based on camera 120 being a wide angle camera). In some implementations, camera 120 may be affixed to a lid of enclosure 115, or to another part of enclosure 115 (e.g., a ceiling of enclosure 115, a side of enclosure 115, and/or the like). In some implementations, camera 120 may not be affixed to enclosure 115.

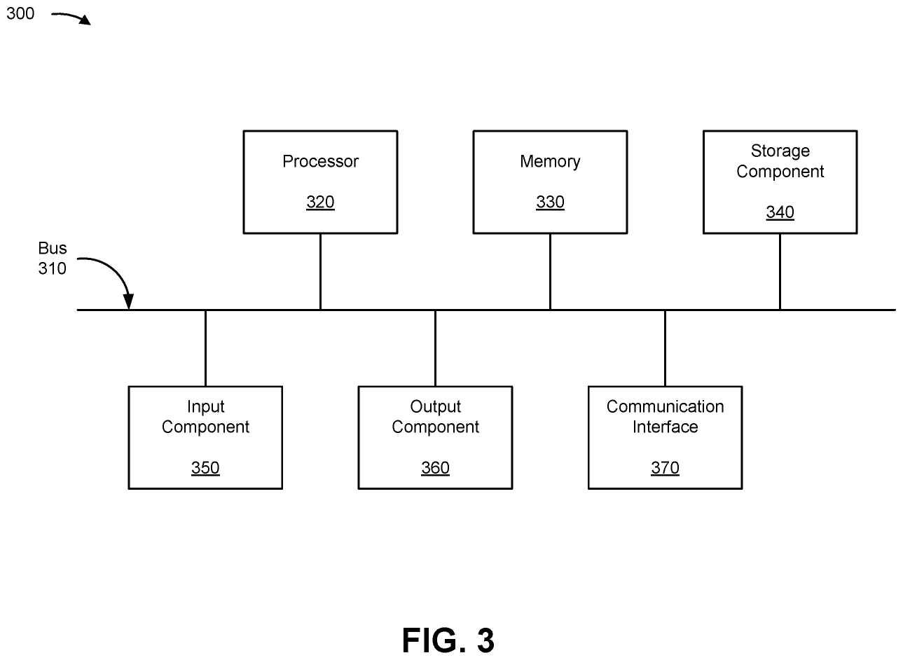

Subject tracking system 100 may include a processor 125. For example, subject tracking system 100 may include one or more processors such as processor 320, described in connection with FIG. 3. In some implementations, processor 125 may be associated with a local computing system, such as a low-cost or low-power computing system (e.g., a Raspberry Pi, a mini-computer, and/or the like). In some implementations, processor 125 may be associated with a wireless local area network (WLAN) communication interface, such as a WiFi communication interface, a Bluetooth communication interface, and/or the like. Processor 125 may communicate with one or more other devices (e.g., a management device (not shown in FIG. 1), camera 120, interaction device 135, and/or the like) using the WLAN communication interface or another form of interface, such as a wired interface. In some implementations, processor 125 may be associated with local storage (not shown in FIG. 1), which may be capable of storing video information, images, metadata, or log information determined or generated by subject tracking system 100.

In some implementations, camera 120 may provide video information to processor 125. For example, camera 120 may provide a video file, a segment of a video, a video feed, a series of images, and/or the like. Processor 125 may process the video information to identify subjects 105, as described elsewhere herein. For example, processor 125 may process the video information in real time or substantially real time using a non-merged computer vision technique or a shape context based computer vision technique based on whether subjects 105 have merged.

Subject tracking system 100 may include one or more light sources 130. Light source 130 includes any device capable of emitting light that can be observed by camera 120. In some implementations, light source 130 may include a light-emitting diode (LED), a group of LEDs, and/or the like. In some implementations, light source 130 may emit light in the IR range or the NIR range, thereby reducing interruption of circadian rhythms of subjects 105. In some implementations, light source 130 may be controllable by processor 125.

Subject tracking system 100 may include one or more interaction devices 135. Interaction device 135 includes any device capable of performing an interaction with subject 105. For example, interaction device 135 may include a feeder or feeding port, a watering device, a shocker, a door, a light source, an element of a maze, and/or the like. The interaction may include any action that can be performed by interaction device 135, such as dispensing food or water, performing a shock, opening a door or maze element, activating or deactivating a light source, and/or the like. In some implementations, interaction device 135 may include a sensor, such as a light sensor, a weight sensor, an IR or NIR sensor, a lickometer, and/or the like. In such a case, the interaction may include performing a sensing operation. A lickometer is a device that measures licking actions or drinking actions, such as actions associated with a drinking tube.

Interaction device 135 may be controllable by processor 125 and/or by a management device. For example, interaction device 135 may perform an interaction based on receiving a signal from processor 125 and/or a management device. In some implementations, interaction device 135 may be associated with a condition for the signal. For example, processor 125 or a management device may determine that a condition is satisfied, and may trigger interaction device 135 to perform an interaction based on the condition. In some implementations, processor 125 or a management device may determine that the condition is satisfied based on the log information, the metadata, a user interaction, a time, the video information, and/or the like. For example, the condition may relate to a previous location of a subject 105, an activity level of a subject 105, and/or the like. In some implementations, the condition may relate to a particular subject 105. For example, the condition may indicate that only a particular subject (or a particular set of subjects) is to be provided access to a particular feeding port, and that other feeding ports are to be blocked for the particular subject or the particular set of subjects.

As indicated above, FIG. 1 is provided merely as one or more examples. Other examples may differ from what is described with regard to FIG. 1.

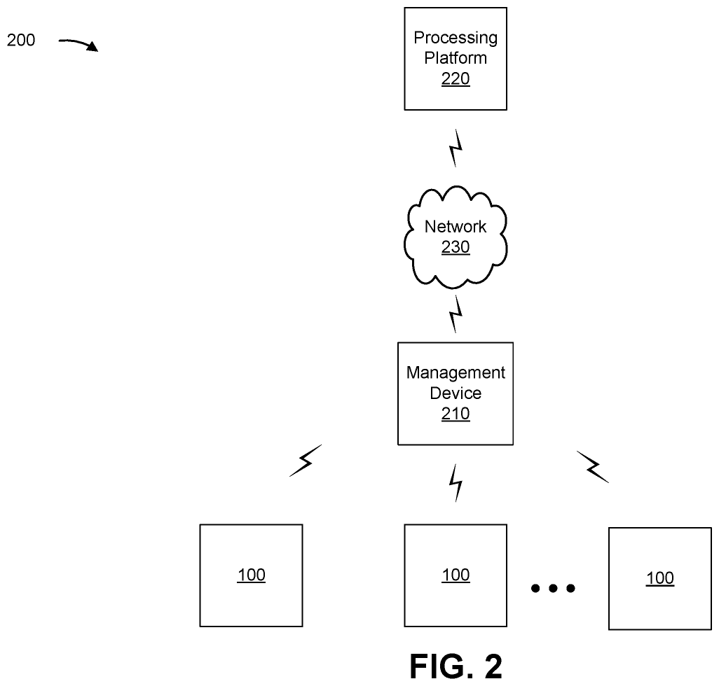

FIG. 2 is a diagram of an example environment 200 in which systems and/or methods described herein may be implemented. As shown in FIG. 2, environment 200 may include one or more subject tracking systems 100, a management device 210, a processing platform 220, and a network 230. Devices of environment 200 may interconnect via wired connections, wireless connections, or a combination of wired and wireless connections.

Management device 210 includes one or more devices capable of communicating with subject tracking system 100, storing data received from subject tracking system 100, processing data received from subject tracking system 100, and/or transmitting data or control information to subject tracking system 100. For example, management device 210 may include a desktop computer, a laptop computer, a tablet computer, a server, a group of servers, a base station, one or more computing resources of a cloud computing environment, and/or the like. In some implementations, management device 210 may be associated with a WLAN communication interface, such as a WiFi interface (e.g., a 5 GHz WiFi interface or another type of WiFi interface), a Bluetooth interface, a Near Field Communication interface, and/or the like. For example, management device 210 may include or be associated with a WiFi access point, a WiFi switch, and/or the like. In some implementations, management device 210 may be associated with a processor, such as a multi-core processor, a graphics processing unit, and/or the like. In some implementations, management device 210 may be associated with storage resources, such as storage resources sufficient to store video clips, log information, and/or metadata received from subject tracking system 100.

Processing platform 220 includes one or more devices capable of receiving, storing, providing and/or processing data provided by management device 210. For example, processing platform 220 may include a desktop computer, a laptop computer, a tablet computer, a server, a group of servers, a base station, one or more computing resources of a cloud computing environment, and/or the like. In some implementations, processing platform 220 may provide a user interface, a web portal, and/or the like, as described in more detail elsewhere herein.

Network 230 includes one or more wired and/or wireless networks. For example, network 230 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a WLAN, a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300. Device 300 may correspond to camera 120, processor 125, management device 210, and processing platform 220. In some implementations, camera 120, processor 125, management device 210, and/or processing platform 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among multiple components of device 300. Processor 320 is implemented in hardware, firmware, and/or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

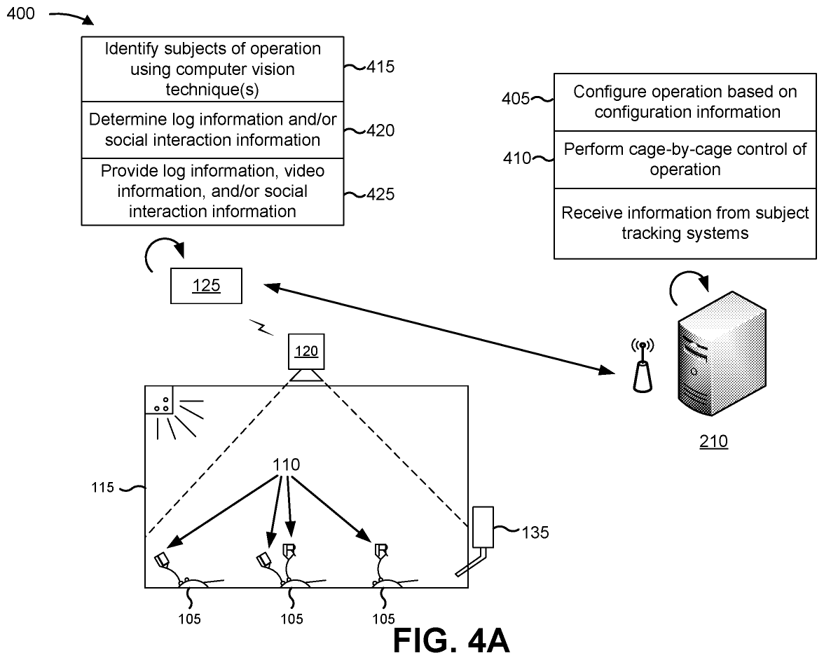

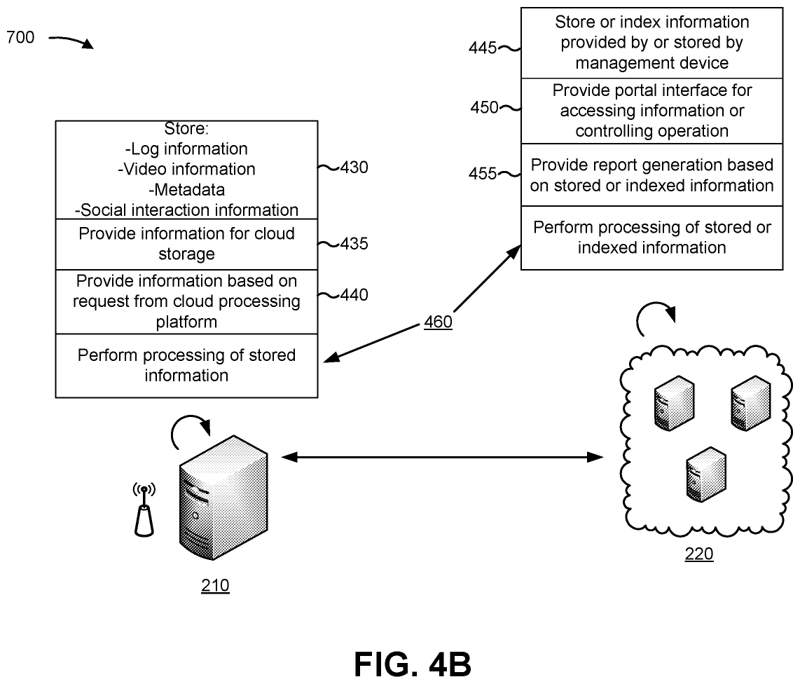

FIGS. 4A and 4B are diagrams of an example of operations performed by a system 400 described herein. As shown in FIGS. 4A and 4B, system 400 includes a subject tracking system 100, a management device 210, and a processing platform 220 (shown in FIG. 4B). In some implementations, the operations performed by system 400 may relate to an experiment, a group of experiments, a part of an experiment, and/or the like. While a single subject tracking system 100 and management device 210 are shown in FIGS. 4A and 4B, it should be understood that the techniques described in example 400 can be applied for any number of subject tracking systems 100 and management devices 210. For example, these techniques can be applied for a single management device 210 that manages a plurality of subject tracking systems 100, for multiple management devices 210 that each manage a single subject tracking system 100, or for multiple management devices 210 that each manage a respective plurality of subject tracking systems 100.

As shown by reference number 405, the management device 210 may configure the operation based on configuration information. For example, the configuration information may indicate a condition for an interaction device 135, an interaction device 135 to be used for the operation, identities or quantities of subjects 105 (e.g., based on tags 110 and/or the like) and/or subject tracking systems 100 to be used for the operation, data storage or provision rules for subject tracking system 100, a software module to be used for processing of the operation (e.g., for classification of behavior, social hierarchy, and/or the like), a telemetry value to be collected, data processing operations to be performed by management device 210, a trigger condition based on which management device 210 is to store or provide data (e.g., log information, video information, metadata, processed information, and/or the like) to processing platform 220, and/or the like.

As shown by reference number 410, management device 210 may be capable of performing cage-by-cage control of the operation. For example, management device 210 may individually control or configure subject tracking systems 100 based on the configuration information. In some implementations, management device 210 may manage multiple subject tracking systems 100 (e.g., ten subject tracking systems 100, thirty subject tracking systems 100, fifty subject tracking systems 100, and/or the like). Thus, management device 210 may reduce the capabilities required of subject tracking system 100 by handling more intensive processing and storage than subject tracking system 100, thereby reducing the expense and complexity of subject tracking system 100. As another example, management device 210 may control respective interaction devices 135 of each subject tracking system 100, or may configure each subject tracking system 100 to control a respective interaction device 135 based on the configuration information.

In some implementations, management device 210 may control a subject tracking system 100 (e.g., processor 125, interaction device 135, light source 130, and/or the like) based on information received from processing platform 220 (shown in FIG. 4B). For example, processing platform 220 may provide an interface for user interaction, such as a web portal and/or the like, that permits a user to provide an instruction regarding control of subject tracking system 100. Management device 210 may receive the instruction, and may cause subject tracking system 100 to perform an action based on the instruction. In this way, remote or cloud-based control of subject tracking systems 100 is provided, thereby improving consistency of experimentation across different geographical locations, laboratories, and/or the like.

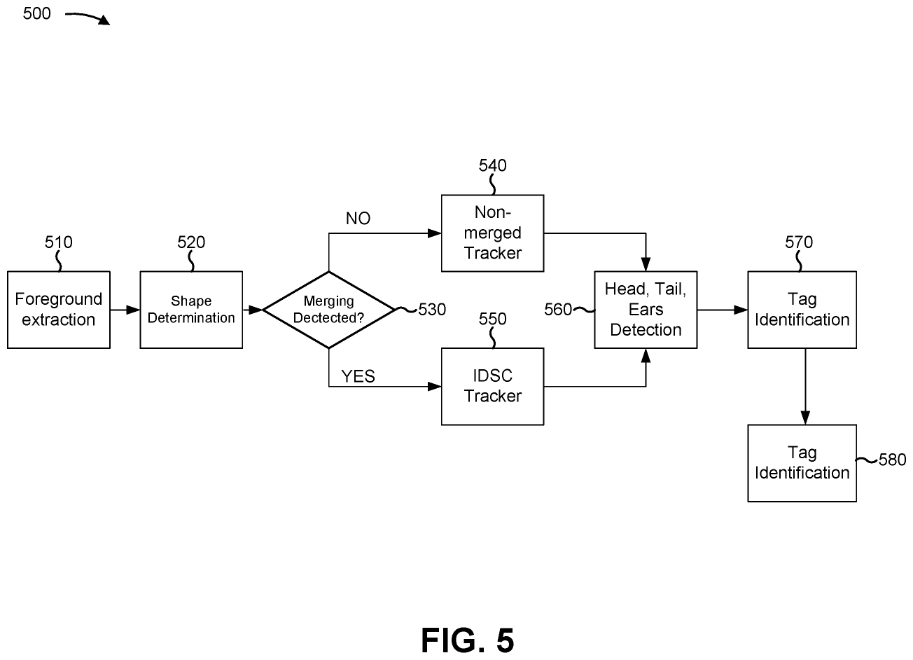

As shown by reference number 415, processor 125 may identify subjects 105 using one or more computer vision techniques. In some implementations, processor 125 may identify subjects 105 using at least one of a non-merged computer vision technique (when two or more subjects are not merged with each other in a frame) or a merged computer vision technique (when two or more subjects are merged with each other in a frame). For a more detailed description of identifying subjects 105 using one or more computer vision techniques, refer to the description accompanying FIGS. 5-7.

As shown by reference number 420, processor 125 may determine log information and/or social interaction information based on identifying the subjects 105 using the one or more computer vision techniques. For example, the log information may include information identifying a subject, an average speed or velocity of a subject, a speed vector associated with the subject, an area of a blob associated with the subject, a length of a major axis of the blob associated with the subject, a length of a minor axis of a blob associated with the subject, an eccentricity of a blob associated with the subject, an orientation of a blob associated with a subject, a position of a subject, and/or the like. The social interaction information may indicate social interactions between subjects 105, for example, based on locations of the subjects 105, interactions between nose points of the subjects 105, orientations of the subjects 105 relative to each other, and/or the like. In some implementations, the social interaction information may indicate a frequency of social interactions, a number of social interactions, a type of a social interaction, particular subjects involved in a social interaction, and/or the like. A blob associated with a subject may be a visual representation of the subject in an image or a video feed.

In some implementations, the social interaction information may be determined by processor 125, thereby conserving resources of management device 210 and/or processing platform 220 and reducing an amount of video information or log information to be transmitted to management device 210 and/or processing platform 220. In some implementations, the social interaction information may be determined by management device 210 and/or processing platform 220, thereby reducing processing load at processor 125 and improving efficiency of determining the social interaction information.

As shown by reference number 425, processor 125 may provide at least one of log information, video information, and/or social interaction information to the management device 210. In some implementations, processor 125 may provide such information periodically (e.g., based on a period that may be configured by management device 210 or that may be based on storage and/or processing capabilities of processor 125). In some implementations, processor 125 may provide information based on a request for the information. For example, processor 125 may receive a request (e.g., from management device 210 or processing platform 220) that identifies particular information (e.g., log information, video information, social interaction information, metadata, and/or the like), such as information associated with a particular range (e.g., a time range, a speed range, a location range, and/or the like), information associated with a particular subject, information associated with a particular type of social interaction, information associated with an interaction with an interaction device 135, and/or the like). Processor 125 may provide the particular information based on the request. Thus, processor 125 may selectively provide information based on a request, which may conserve resources that would otherwise be used to indiscriminately provide such information.

In some implementations, processor 125 may provide all video information to management device 210 (and/or processing platform 220), which conserves processor resources that would otherwise be used to identify particular segments of video information to provide to management device 210. In some implementations, processor 125 may provide a segment of video information to management device 210. For example, processor 125 may provide segments of video information associated with a social interaction, segments of video requested by management device 210, segments of video that satisfy a condition, periodic segments of video, and/or the like. This may conserve transmission resources of processor 125 and/or resources of management device 210 that would otherwise be used to communicate all video information captured by processor 125.

As shown by reference numbers 430, 435, and 440, management device 210 may store and/or provide information associated with the operation. For example, as shown by reference number 430, management device 210 may store log information, video information, metadata, social interaction information, and/or the like. In some implementations, management device 210 may store information from multiple, different subject tracking systems 100 in connection with an operation. In some implementations, management device 210 may store information from two or more groups of subject tracking systems 100 in connection with respective operations of the two or more groups of subject tracking systems 100.

In some implementations, as shown by reference number 435, management device 210 may provide information to processing platform 220 for storage. For example, management device 210 may provide information that satisfies a trigger condition, such as one or more of the trigger conditions described above for providing information from processor 125 to management device 210, to processing platform 220. In some implementations, management device 210 may provide particular information, such as a particular type of information, to processing platform 220. For example, management device 210 may provide log information, social interaction information, and metadata, and may provide video information only when a request for the video information is received.

As shown by reference number 440, in some implementations, management device 210 may provide information based on a request from processing platform 220. For example, processing platform 220 may request particular information based on a user request for the particular information, based on a processing operation to be performed by processing platform 220, and/or the like. Management device 210 may provide the particular information based on the request. Thus, management device 210 may conserve resources that would otherwise be used to indiscriminately provide information to processing platform 220.

As shown by reference number 445, the processing platform 220 may store or index information provided by or stored by management device 210. For example, processing platform 220 may store information provided by management device 210, or may index information stored by management device 210. Storing the information provided by management device 210 may allow processing platform 220 to perform processing on the information, as described in more detail elsewhere herein. Indexing the information may conserve resources of processing platform 220 relative to storing the information.

As shown by reference number 450, processing platform 220 may provide a portal interface, such as a web portal and/or the like. For example, the portal interface may allow a user to access information stored by management device 210 or processing platform 220. As another example, the portal interface may allow a user to control or configure an operation or a device (e.g., management device 210 or subject tracking system 100). The web portal may allow collaborators or a scientific community to access information captured by subject tracking system 100 and/or algorithms used to capture or process the information. This may improve the reproducibility of experimental results and may allow multiple different parties to process information captured by subject tracking system 100. Furthermore, this portal interface may be useful for developing computer vision algorithms, tracking and activity logging algorithms, and data mining algorithms.

As shown by reference number 455, processing platform 220 may provide report generation based on the stored or indexed information. For example, processing platform 220 may generate a report based on log information, video information, metadata, and/or social interaction information. In some implementations, processing platform 220 may generate the report based on the portal interface. For example, processing platform 220 may receive an instruction, via the portal interface, to generate a report based on one or more criteria (e.g., “Identify all subjects associated with a threshold rate of social interaction after being exposed to a particular medication for a threshold length of time”). Processing platform 220 may identify and/or retrieve data (e.g., from management device 210) based on the instruction, and may generate a report identifying the data based on the instruction. This provides more efficient access to data and improved consistency of data across multiple testing facilities and/or experiments in comparison to individually gathering the data (e.g., manually) from different management devices 210 or different subject tracking systems 100.

As shown by reference number 460, processing platform 220 and/or management device 210 may perform processing of stored information. For example, management device 210 may process stored information that is received from one or more subject tracking systems 100 associated with management device 210. As another example, processing platform 220 may process information that is received from one or more management devices 210.

In some implementations, management device 210 may perform processing of log information, video information, social interaction information, and/or metadata received from one or more subject tracking systems 100. For example, management device 210 may determine social interaction information (e.g., an interaction type, an interaction frequency and/or the like), cognitive phenotypes, behavioral phenotypes, a body posture associated with a particular activity (e.g., running, drinking, rearing, and/or the like) and/or the like based on the log information, the video information, and/or the metadata. In some implementations, management device 210 may request video information based on processing the log information and/or the metadata. For example, management device 210 may identify a particular behavior, social interaction, and/or the like using the log information and/or the metadata, and may request or obtain, from subject tracking system 100, relevant video information. In some implementations, management device 210 may link the relevant video information with information indicating the particular behavior, social interaction, and/or the like. This may conserve bandwidth and/or processor resources that would otherwise be used to provide irrelevant video information from subject tracking system 100.

In some implementations, processing platform 220 may perform processing of information received from subject tracking system 100 and/or management device 210. For example, processing platform 220 may perform analysis of information received from multiple, different subject tracking systems 100 and/or management devices 210. For example, processing platform 220 may perform big data analysis and/or the like to identify trends, common behaviors, and/or the like across many different subject tracking systems 100. Processing platform 220 may provide information indicating such trends, common behaviors, and/or the like, or may provide an interface for accessing this information. In this way, processing platform 220 may improve the efficiency of identification of trends in animal research across many enclosures and testing institutions, thereby improving efficiency, usefulness, and reproducibility of the animal research.

In some implementations, management device 210 and/or processing platform 220 may perform a machine learning based analysis of log information, video information, social interaction information, and/or metadata. For example, management device 210 may use a machine learning model to identify behaviors of mice including social interaction types, social interaction frequency, body posture, and/or the like. Management device 210 may train or update the machine learning model, using a machine learning technique, based on feedback regarding the identification of the behaviors, social interaction frequency, body posture, and/or the like. For example, management device 210 may receive this feedback from processing platform 220 (e.g., from users of processing platform 220). The utilization of machine learning models to analyze information gathered by subject tracking system 100 and/or management device 210 may improve uniformity and accuracy of analysis, particularly across multiple, different management devices 210. This, in turn, may improve the reproducibility and accuracy of experiments conducted using the multiple, different management devices 210.

As indicated above, FIGS. 4A and 4B are provided merely as an example. Other examples may differ from what is described with regard to FIGS. 4A and 4B.

FIG. 5 is a diagram of an example process 500 for subject tracking, as described herein. The operations described in connection with FIG. 5 may be performed by any one or more devices of environment 200 (e.g., subject tracking system 100, management device 210, and/or processing platform 220), though these operations are referred to herein as being performed by subject tracking system 100. For the purpose of process 500, subject tracking system 100 receives a video feed including a plurality of frames.

As shown by reference number 510, subject tracking system 100 may perform foreground extraction on a set of frames (e.g., two or more frames). For example, subjects may move within an enclosure (e.g., enclosure 115) that includes various static or semi-static objects, such as a background, one or more interaction devices (e.g., interaction device 135), and/or the like. Subject tracking system 100 may extract a foreground (e.g., the subjects and any other non-static features) from a set of frames. For example, subject tracking system 100 may average multiple frames and subtract differences between the frames in order to identify the static or semi-static objects. In some implementations, subject tracking system 100 may identify an interaction device using an image processing technique and/or the like, and may remove the interaction device from the background. In this way, movement of subjects may be tracked relative to a static or semi-static background determined using foreground extraction. Subject tracking system 100 may remove the identified background from a frame in which the subjects are to be tracked, thereby simplifying tracking of the subjects and reducing processor usage associated with tracking subjects on a noisy background.

As shown by reference number 520, subject tracking system 100 may perform shape determination on the frame. For example, subject tracking system 100 may extract geometric information from segmented points of a shape of a frame. Subject tracking system 100 may determine a shape for each subject of a frame based on the segmented points. For example, subject tracking system 100 may determine at least one of an ellipse associated with a subject, a centroid associated with a subject, a contour associated with a subject, a major and/or minor axis of the ellipse, axis endpoints of the major and/or minor axis, an eccentricity of the ellipse, an orientation of the ellipse, and/or the like.

As shown by reference number 530, subject tracking system 100 may determine whether merging is detected. As described herein, merging may refer to a condition when two or more subjects are sufficiently close to each other that a single shape is identified for the two or more subjects in connection with reference number 520. In some implementations, subject tracking system 100 may determine (e.g., perform an approximation of) one or more shapes of subjects that are merged in a frame. For example, subject tracking system 100 may perform k-means clustering to divide points belonging to different subjects in the same shape, and may perform a direct least squares fitting method to define ellipses that best fit those points. Subject tracking system 100 may initiate the k-means clustering with the centroid positions detected in a previous frame where merging did not occur.

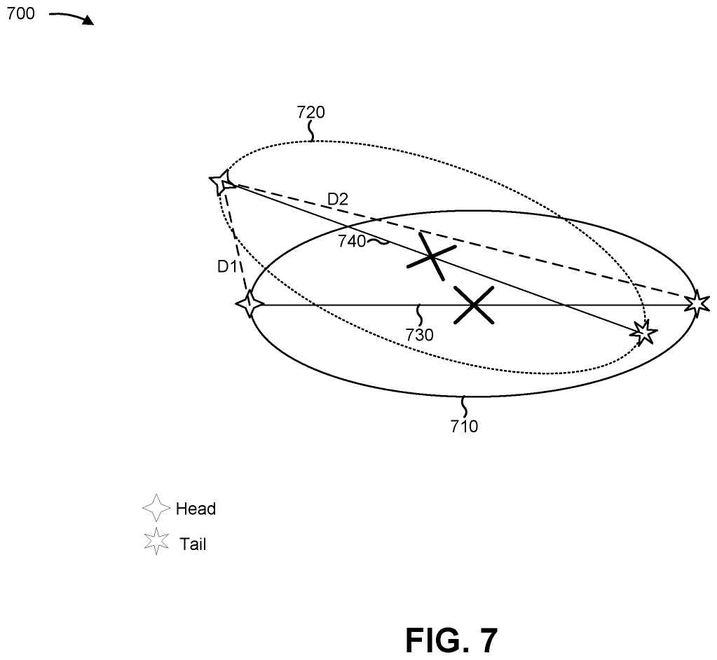

As shown by reference number 540, if merging is not detected (block 530— NO), then subject tracking system 100 may perform a non-merged computer vision technique (shown as “non-merged tracker”). For example, if no merging occurred in a frame, then head and tail locations are available from a previous frame. In this case, subject tracking system 100 may determine reference points (e.g., head points, tail points, ear points, and/or the like) using the non-merged computer vision technique described in connection with FIG. 7, below. In some implementations, the non-merged computer vision technique may be performed in real time or substantially real time (e.g., frame-by-frame, as frames are received, before a next frame is received, and/or the like), which improves efficiency of analysis of the log information.

As shown by reference number 550, if merging is detected (block 530— YES), then subject tracking system 100 may perform a merged computer vision technique (shown as inner distance shape context (IDSC) tracker), which may be based on a shape context of the merged shape. For example, subject tracking system 100 may perform an IDSC-based computer vision technique to identify reference points of two or more subjects that are merged. In this case, subject tracking system 100 may perform shape context matching to identify a correspondence between a reference shape of a subject and a current shape of a subject. For example, considering n points p₁, p₂, pₙ on a shape contour, and looking at the relative Euclidean distance and orientation distribution for each point pᵢ to the remaining points of the contour, a rich descriptor of the point pᵢ may be determined. In other words, for each point pᵢ on the edge of the shape, a histogram hᵢ of the relative coordinates of the remaining n-1 points is computed as follows: hᵢ(k)=#{pⱼ: j≠, pⱼ-pᵢ ∈bin(k)}, where the function #{.} indicates the number of points that satisfy the condition in brackets. The histogram h, defines the shape context of the point pᵢ. The log-polar space may be used to make the descriptor more sensitive to the position of nearby points than to the farther ones.

Once the shape context histogram for each point on the first shape pᵢ and for each point on the second shape pⱼ is built, a cost function Cᵢⱼ=C(pᵢ, pⱼ) may be defined as: Cᵢⱼ ≡C(pᵢ,pⱼ)=½Σₖ^{k}=1[hᵢ(k)=hⱼ (k)]²/[hᵢ(k)=hⱼ (k)], where hᵢ(k) and hⱼ(k) denote the value of the histogram evaluated at the k-bin at pᵢ on the first shape and pᵢ on the second shape, respectively. The cost function may also include an additional term, referred to as an appearance similarity (AS), at points pᵢ and pⱼ. The AS may depend on the application and may be modified based on robustness requirements. Once all contour points on the two shapes are matched and costs are calculated, the total cost of matching, given by the sum of the individual costs, may be minimized using weighted bipartite matching.

The inner distance may be defined as the length of the shortest path connecting two points within a shape. The inner distance may be more suitable to build a shape descriptor for an articulated object than a Euclidean distance. Accordingly, the IDSC algorithm may provide improved performance relative to a non-inner-distance-based approach. IDSC shape matching may follow the same steps as the shape context procedure described above, with the difference that histograms of each point on contours are obtained by mapping an inner distance and an inner angle. Once the IDSC is defined for each point of the contour on the first shape and on the second shape, the cost function may be minimized using dynamic programming, and the matching problem may be solved.

In some aspects, the IDSC computer vision process may use multiple reference shapes. For example, the IDSC computer vision process may use reference shapes associated with landmark points on multiple different subject postures, such as tens of shapes, hundreds of shapes, and/or the like. In some implementations, the IDSC computer vision process may be based on a set of clusters of subject postures. For example, the IDSC computer vision process may be performed based on each cluster of subject postures, of the set of clusters. Using clusters of subject postures may reduce computational complexity relative to performing the IDSC computer vision process using every subject posture of the reference shapes while improving robustness of the IDSC computer vision process relative to using a single subject posture or reference shape.

In some aspects, a same device may perform the merged computer vision technique and the non-merged computer vision technique. For example, subject tracking system 100 may perform the merged computer vision technique and the non-merged computer vision technique, which may reduce communication resource usage associated with providing video information for another device to perform the non-merged computer vision technique. In some aspects, different devices may perform the merged computer vision technique and the non-merged computer vision technique. For example, subject tracking system 100 may perform the non-merged computer vision technique, and another device (e.g., management device 210 or processing platform 220) may perform the merged computer vision technique, which conserves processor resources of subject tracking system 100 and provides for a device with more computing power than subject tracking system 100 to perform the merged computer vision technique, which may be more processor-intensive than the non-merged computer vision technique.

In some aspects, subject tracking system 100 may determine that a subject is not identifiable or may mis-identify a subject. This may happen when, for example, the tags are not visible or when the subjects overlap in particular ways. In such cases, subject tracking system 100 may backpropagate identities to older frames in which the identity have been accurately determined. Additionally, or alternatively, subject tracking system 100 may treat each video segment with well identified tracks for each subject as an independent stream of video. The behaviors within each stream may then be analyzed separately to produce disjointed logs. Using these disjointed logs, the identities and activities may be reconnected in a higher level of processing (e.g. at the management device) to produce a contiguous log of activity.

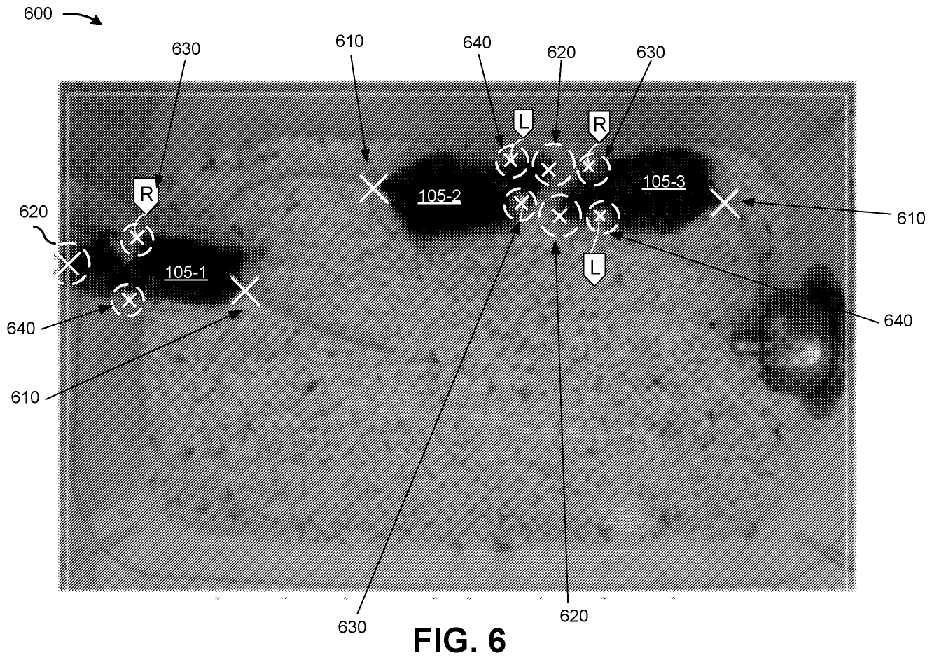

As shown by reference number 560, subject tracking system 100 may perform detection of one or more reference points of a subject. Here, the reference points include a head point, a tail point, and one or more ear points. For example, subject tracking system 100 may detect the one or more reference points using the merged computer vision technique or the non-merged computer vision technique. Examples of such reference points are shown in FIG. 6. As shown by reference number 570, subject tracking system 100 may identify one or more tags (e.g., tag 110) associated with a subject, which is described in more detail in connection with FIG. 6.

As shown by reference number 580, subject tracking system 100 may identify the subject. For example, subject tracking system 100 may identify the subject based on the computer vision technique used to identify the subject and based on the one or more reference points. Here, subject tracking system 100 may identify subjects 105-1, 105-2, and 105-3 based on information indicating which ear tags (e.g., no ear tags, only left ear tag, only right ear tag, or both ear tags) are associated with each subject. Thus, subject tracking system 100 may identify subjects using one or more computer vision techniques in a video, thereby enabling concurrent monitoring of multiple subjects in an enclosure even when the multiple subjects can combine into a single shape in the video. This enables larger scale testing without interrupting social groups of the subjects, thereby facilitating the collection of social interaction information and improving reproducibility of experiments.

As indicated above, FIG. 5 is provided merely as an example. Other examples may differ from what is described with regard to FIG. 5.

FIG. 6 is a diagram of an example 600 of reference points of a set of subjects, as described herein. In FIG. 6, tail reference points (sometimes referred to as tail points) are indicated by reference number 610 and by a white X at the tail of each subject 105. Nose reference points (sometimes referred to as nose points or head points) are indicated by reference number 620 and are shown by a dark gray X and a white dashed circle around the nose of each subject 105. Respective locations for a right ear tag (e.g., tag 110) are shown by reference number 630 using a dashed circle and a small white X. The presence of a right ear tag is denoted by an “R” label. For example, subjects 105-1 and 105-3 are associated with right ear tags and subject 105-2 is not associated with a right ear tag. Respective locations for a left ear tag (e.g., tag 110) are shown by reference number 640 using a dashed circle and a small white X. For example, subjects 105-2 and 105-3 are associated with a left ear tag, and subject 105-1 is not associated with a left ear tag. Thus, subjects 105-1, 105-2, and 105-3 can be differentiated from each other based on the combination of ear tags shown by reference numbers 630 and 640 associated with each subject, such as in process 500 at block 560.

FIG. 7 is a diagram of an example 700 of subject tracking based on centers of a shape associated with a subject and reference points associated with the subject, as described herein. Example 700 shows shapes (e.g., ellipses, blobs, and/or the like) that are assigned to a subject (e.g., subject 105) as part of a non-merged computer vision technique, such as non-merged computer vision technique shown by block 540 of process 500. Example 700 includes a first shape 710 and a second shape 720, which may correspond to a first frame and a second frame of a video (e.g., consecutive frames or nonconsecutive frames). Shape 710 is denoted by a solid outline and shape 720 is denoted by a dotted outline. Respective center lines of shape 710 and 720 are shown by reference numbers 730 and 740. A centroid of each shape is shown by a black X. In the case when subject tracking system 100 is tracking multiple subjects, subject tracking system 100 may identify each subject in the second frame based on respective distances from the centroid of each shape in the first frame. For example, if two shapes are in the second frame, subject tracking system 100 may match each shape to a respective shape in the first frame that is closest to each shape based on the centroid of each shape in the first frame and the second frame.

Head points of each shape are shown by four-sided stars, and tail points of each shape are shown by six-sided stars. In this example, subject tracking system 100 may identify the head point and the tail point of shape 720 based on a location of a head point (or a tail point) of shape 710. For example, subject tracking system 100 may identify the head point of shape 720 as a head point based on a distance from the head point of shape 710 to the head point of shape 720 (shown as D1) being shorter than a distance from the head point of shape 710 to the tail point of shape 720 (shown as D2). If D2 were a shorter distance than D1, then subject tracking system 100 may instead identify the current tail point of shape 720 as the head point of shape 720 (i.e., the head point and tail point of shape 720 would be switched with each other).

As indicated above, FIG. 7 is provided as an example. Other examples may differ from what is described with regard to FIG. 7.

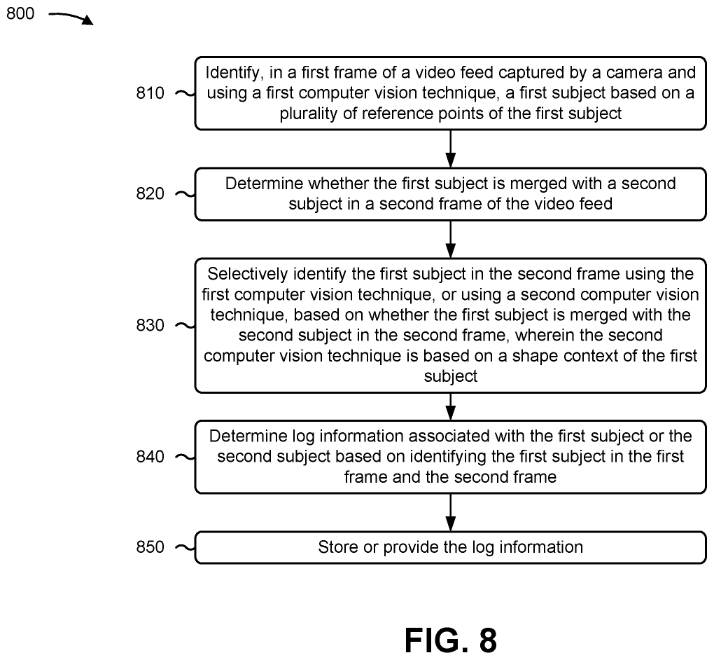

FIG. 8 is a flow chart of an example process 800 for tracking subjects using a subject tracking system. In some implementations, one or more process blocks of FIG. 8 may be performed by a subject tracking system (e.g., subject tracking system 100). In some implementations, one or more process blocks of FIG. 8 may be performed by another device or a group of devices separate from or including the subject tracking system, such as management device 210, processing platform 220, and/or the like.

As shown in FIG. 8, process 800 may include identifying, in a first frame of a video feed captured by a camera and using a first computer vision technique, a first subject based on a plurality of reference points of the first subject (block 810). For example, the subject tracking system (e.g., using processor 320, memory 330, storage component 340, input component 350, and/or the like) may identify, in a first frame of a video feed captured by a camera and using a first computer vision technique, a first subject based on a plurality of reference points of the first subject, as described above.

As further shown in FIG. 8, process 800 may include determining whether the first subject is merged with a second subject in a second frame of the video feed (block 820). For example, the subject tracking system (e.g., using processor 320, memory 330, storage component 340, and/or the like) may determine whether the first subject is merged with a second subject in a second frame of the video feed, as described above.

As further shown in FIG. 8, process 800 may include selectively identifying the first subject in the second frame using the first computer vision technique, or using a second computer vision technique, based on whether the first subject is merged with the second subject in the second frame, wherein the second computer vision technique is based on a shape context of the first subject (block 830). For example, the subject tracking system (e.g., using processor 320, memory 330, storage component 340, and/or the like) may selectively identify the first subject in the second frame using the first computer vision technique (e.g., a non-merged computer vision technique), or using a second computer vision technique (e.g., a merged computer vision technique). The subject tracking system may select the computer vision technique based on whether the first subject is merged with the second subject in the second frame. The second computer vision technique may be based on a shape context of the first subject, as described above.

As further shown in FIG. 8, process 800 may include determining log information associated with the first subject or the second subject based on identifying the first subject in the first frame and the second frame (block 840). For example, the subject tracking system (e.g., using processor 320, memory 330, storage component 340, and/or the like) may determine log information associated with the first subject or the second subject based on identifying the first subject in the first frame and the second frame, as described above.

As further shown in FIG. 8, process 800 may include storing or providing the log information (block 850). For example, the subject tracking system (e.g., using processor 320, memory 330, storage component 340, output component 360, communication interface 370, and/or the like) may store or provide the log information, as described above.

Process 800 may include additional implementations, such as any single implementation or any combination of implementations described below and/or in connection with one or more other processes described elsewhere herein.

In a first implementation, the first subject and the second subject are laboratory animals.

In a second implementation, alone or in combination with the first implementation, the first subject in the second frame is identified based on a plurality of reference points that include or are based on at least one of: a head point, a tail point, or one or more ear tags.

In a third implementation, alone or in combination with one or more of the first and second implementations, the first subject is differentiated from the second subject based on which ear tags, of the one or more ear tags, are affixed to the first subject and the second subject.

In a fourth implementation, alone or in combination with one or more of the first through third implementations, the one or more ear tags are observable by the camera.

In a fifth implementation, alone or in combination with one or more of the first through fourth implementations, the camera is associated with a wide angle lens.

In a sixth implementation, alone or in combination with one or more of the first through fifth implementations, the camera captures images in a near-infrared range. In some implementations, the first subject and the second subject are illuminated using near-infrared light.

In a seventh implementation, alone or in combination with one or more of the first through sixth implementations, the enclosure comprises a mouse vivarium.

In an eighth implementation, alone or in combination with one or more of the first through seventh implementations, the first computer vision technique is based on determining respective first outlines and respective first centers of the first subject and the second subject in the first frame and respective second outlines and respective second centers of the first subject and the second subject in the second frame. In some implementations, identifying the first subject in the second frame is based on a distance between the first center of the first subject and the second center of the first subject being smaller than a distance between the first center of the first subject and the second center of the second subject.

In a ninth implementation, alone or in combination with one or more of the first through eighth implementations, the log information indicates at least one of: a distance moved by the first subject, a position of the first subject, a pose of the first subject, a speed of the first subject, a social behavior of the first subject, or a feeding behavior of the first subject.

In a tenth implementation, alone or in combination with one or more of the first through ninth implementations, the first computer vision technique is performed in real time or substantially in real time. For example, the first computer vision technique may be performed as frames are received or captured, within a threshold length of time of frames being received or captured, and/or the like.

In an eleventh implementation, alone or in combination with one or more of the first through tenth implementations, the subject tracking system may provide, to a management device associated with the one or more processors, at least a segment of the video feed.

In a twelfth implementation, alone or in combination with one or more of the first through eleventh implementations, the subject tracking system may determine that a condition for an interaction associated with the first subject or the second subject is satisfied, and trigger an interaction device to perform the interaction based on the condition for the interaction being satisfied.

In a thirteenth implementation, alone or in combination with one or more of the first through twelfth implementations, the log information includes information that is determined based on the interaction.

In a fourteenth implementation, alone or in combination with one or more of the first through thirteenth implementations, the second computer vision technique is based on an inner distance shape context calculation regarding at least one of the first subject or the second subject.

In a fifteenth implementation, alone or in combination with one or more of the first through fourteenth implementations, the log information includes information regarding a social interaction between the first subject and the second subject.

In a sixteenth implementation, alone or in combination with one or more of the first through fifteenth implementations, the first subject and the second subject are included in a plurality of subjects. In some implementations, the subject tracking system may identify each subject, of the plurality of subjects, in the video feed and store log information identifying each subject of the plurality of subjects and including information regarding the plurality of subjects.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

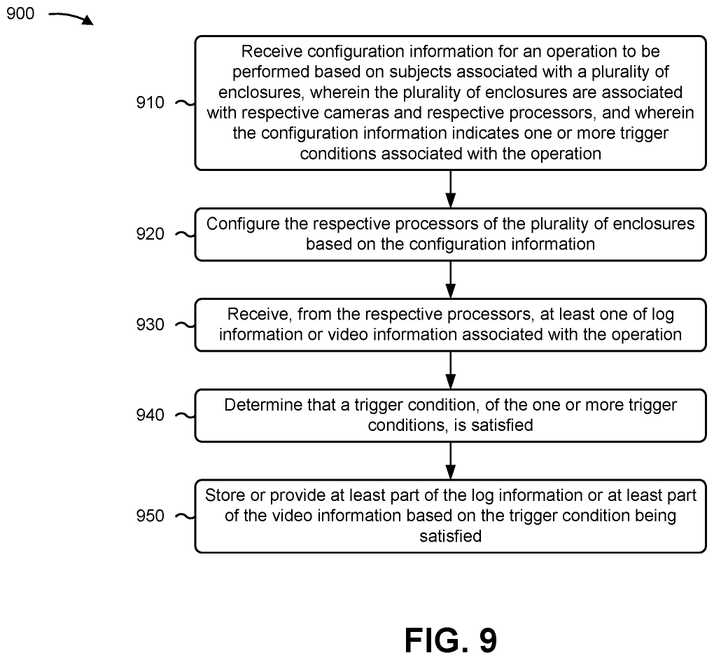

FIG. 9 is a flow chart of an example process 900 for tracking subjects in multiple enclosures. In some implementations, one or more process blocks of FIG. 9 may be performed by a management device (e.g., management device 210). In some implementations, one or more process blocks of FIG. 9 may be performed by another device or a group of devices separate from or including the management device, such as a subject tracking system (e.g., subject tracking system 100), a processing platform (e.g., processing platform 220), and/or the like.

As shown in FIG. 9, process 900 may include receiving configuration information for an operation to be performed based on subjects associated with a plurality of enclosures, wherein the plurality of enclosures are associated with respective cameras and respective processors, and wherein the configuration information indicates one or more trigger conditions associated with the operation (block 910). For example, the management device (e.g., using processor 320, input component 350, communication interface 370, and/or the like) may receive configuration information (e.g., from processing platform 220, from an administrator of the management device, and/or the like) for an operation to be performed based on subjects associated with a plurality of enclosures, as described above. In some aspects, the plurality of enclosures are associated with respective cameras and respective processors (e.g., corresponding cameras and corresponding processors, such as one or more cameras per enclosure and one or more processors per enclosure, or one or more cameras per enclosure and a processor for multiple enclosures). In some aspects, the configuration information indicates one or more trigger conditions associated with the operation.

As further shown in FIG. 9, process 900 may include configuring the respective processors of the plurality of enclosures based on the configuration information (block 920). For example, the management device (e.g., using processor 320, memory 330, output component 360, communication interface 370, and/or the like) may configure the respective processors of the plurality of enclosures based on the configuration information, as described above.

As further shown in FIG. 9, process 900 may include receiving, from the respective processors, at least one of log information or video information associated with the operation (block 930). For example, the management device (e.g., using processor 320, memory 330, storage component 340, input component 350, output component 360, communication interface 370 and/or the like) may receive, from the respective processors, at least one of log information or video information associated with the operation, as described above.

As further shown in FIG. 9, process 900 may include determining that a trigger condition, of the one or more trigger conditions, is satisfied (block 940). For example, the management device (e.g., using processor 320, and/or the like) may determine that a trigger condition, of the one or more trigger conditions, is satisfied, as described above.

As further shown in FIG. 9, process 900 may include storing or providing at least part of the log information or at least part of the video information based on the trigger condition being satisfied (block 950). For example, the management device (e.g., using processor 320, memory 330, storage component 340, input component 350, output component 360, communication interface 370 and/or the like) may store or provide at least part of the log information or at least part of the video information based on the trigger condition being satisfied, as described above.

Process 900 may include additional implementations, such as any single implementation or any combination of implementations described below and/or in connection with one or more other processes described elsewhere herein.

In a first implementation, the configuration information indicates at least one of a number of feed ports for the operation, a probability of an interaction being performed, a condition for an interaction to be performed, or a condition for a notification to be provided.

In a second implementation, alone or in combination with the first implementation, the management device is further configured to trigger an interaction device, associated with a particular enclosure of the plurality of enclosures, to perform an interaction based on the condition.

In a third implementation, alone or in combination with one or more of the first and second implementations, the management device is further configured to provide, to a device associated with a processing platform, at least one of the at least part of the log information, metadata regarding the operation, or metadata regarding the plurality of enclosures.

In a fourth implementation, alone or in combination with one or more of the first through third implementations, the providing is based on a request from the device associated with the processing platform.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by one or more processors, comprising:
identifying, in a first frame of a video feed captured by a camera and using a first computer vision technique, a first subject based on a plurality of reference points of the first subject;
determining whether the first subject is merged with a second subject in a second frame of the video feed;
selectively identifying the first subject in the second frame using the first computer vision technique, or using a second computer vision technique, based on whether the first subject is merged with the second subject in the second frame,
wherein the second computer vision technique is based on a shape context of the first subject;
determining log information associated with the first subject or the second subject based on identifying the first subject in the first frame and the second frame; and
storing or providing the log information.

2. The method of claim 1, wherein the first subject and the second subject are laboratory animals.

3. The method of claim 1, wherein the first subject in the second frame is identified based on a plurality of reference points that include or are based on at least one of:
a head point,
a tail point, or
one or more ear tags.

4. The method of claim 3, wherein the first subject is differentiated from the second subject based on which ear tags, of the one or more ear tags, are affixed to the first subject and the second subject.

5. The method of claim 3, wherein the one or more ear tags are observable by the camera.

6. The method of claim 1, wherein the camera is associated with a wide angle lens.

7. The method of claim 1, wherein the camera captures images in a near-infrared range, and wherein the first subject and the second subject are illuminated using near-infrared light.

8. The method of claim 1, wherein the first computer vision technique is based on determining respective first outlines and respective first centers of the first subject and the second subject in the first frame and respective second outlines and respective second centers of the first subject and the second subject in the second frame,
wherein identifying the first subject in the second frame is based on a distance between the first center of the first subject and the second center of the first subject being smaller than a distance between the first center of the first subject and the second center of the second subject.

9. The method of claim 1, wherein the log information indicates at least one of:
a distance moved by the first subject,
a position of the first subject,
a pose of the first subject,
a speed of the first subject,
a social behavior of the first subject, or
a feeding behavior of the first subject.

10. The method of claim 1, wherein the first computer vision technique is performed in real time or substantially real time.

11. The method of claim 1, further comprising:
providing, to a management device associated with the one or more processors, at least a segment of the video feed.

12. The method of claim 1, further comprising:
determining that a condition for an interaction associated with the first subject or the second subject is satisfied; and
triggering an interaction device to perform the interaction based on the condition for the interaction being satisfied.

13. The method of claim 12, wherein the log information includes information that is determined based on the interaction.

14. The method of claim 1, wherein the second computer vision technique is based on an inner distance shape context calculation regarding at least one of the first subject or the second subject.

15. The method of claim 1, wherein the log information includes information regarding a social interaction between the first subject and the second subject.

16. The method of claim 1, wherein the first subject and the second subject are included in a plurality of subjects, and wherein the method further comprises:
identifying each subject, of the plurality of subjects, in the video feed; and
storing log information identifying each subject of the plurality of subjects and including information regarding the plurality of subjects.

17. A system, comprising:
a mouse vivarium;
a camera to capture a video feed of a floor surface of the mouse vivarium in a near-infrared range or an infrared range;
a near-infrared or infrared light source to illuminate the mouse vivarium;
one or more processors communicatively coupled to the camera and configured to identify one or more subjects in the video feed; and
an interaction device configured to perform an interaction with the one or more subjects in the mouse vivarium based on a signal from the one or more processors.

18. The system of claim 17, further comprising:
a management device configured to receive or store log information or the video feed from the one or more processors.

19. The system of claim 18, further comprising:
a plurality of mouse vivariums associated with corresponding cameras and corresponding processors,
wherein the corresponding processors are configured to transmit, to the management device, respective log information or respective video feeds associated with the plurality of mouse vivariums.

20. The system of claim 18, wherein the one or more processors are configured to communicate with the management device via a wireless local area network (WLAN) connection.

21. A device, comprising:
one or more memories; and
one or more processors, communicatively coupled to the one or more memories, configured to:
receive configuration information for an operation to be performed based on subjects associated with a plurality of enclosures,
wherein the plurality of enclosures are associated with respective cameras and respective processors, and
wherein the configuration information indicates one or more trigger conditions associated with the operation;
configure the respective processors of the plurality of enclosures based on the configuration information;
receive, from the respective processors, at least one of log information or video information associated with the operation;
determine that a trigger condition, of the one or more trigger conditions, is satisfied; and
store or provide at least part of the log information or at least part of the video information based on the trigger condition being satisfied.

22. The device of claim 21, wherein the configuration information indicates at least one of:
a number of feed ports for the operation,
a probability of an interaction being performed,
a condition for an interaction to be performed, or
a condition for a notification to be provided.

23. The device of claim 22, wherein the one or more processors are further configured to:
trigger an interaction device, associated with a particular enclosure of the plurality of enclosures, to perform an interaction based on the condition.

24. The device of claim 23, wherein the one or more processors are further configured to:
provide, to a device associated with a processing platform, at least one of:
the at least part of the log information,
the at least part of the video information,
metadata regarding the operation, or
metadata regarding the plurality of enclosures.

25. The device of claim 24, wherein the providing is based on a request from the device associated with the processing platform.
